(19) United States
(12) Patent Application Publication
(10) Pub. No.: US 2006/0282588 A1
(43) Pub. Date: Dec. 14, 2006

(54) Processor system that allows for simultaneous access by multiple requestors to a target with multiple ports

(76) Inventor: Jonah Proujansky-Bell, Lexington, MA (US)

Correspondence Address: Patrick J. O'Shea, Esq.;O'Shea, Getz & Kosakowski, P.C., Suite 912, 1500 Main Street, Springfield, MA, 01115, US

(21) Appl. No.: 11/148,525

(22) Filed: Jun. 9, 2005

(51) Int. Cl. G06F 13/14

(52) U.S. Cl. 710/240

(57) ABSTRACT

A processor system includes a plurality of processors, along with a target device, e.g., a memory, having two or more ports, and an arbiter that arbitrates access requests from requesting processors. A multiplexer facilitates the flow of control, address and data information over a shared bus. The number of processors requesting access may be greater than the number of target ports. Each processor can issue a request for access to communicate with a target port at any time by a transaction, such as a data read or write. The arbiter may simultaneously grant access to as many requesting processors up to the number of target ports. The arbiter dynamically and arbitrarily allocates each target port to a requesting processor at the time of the request for access, which may occur within each system clock cycle, and each access may last for one or more clock cycles. The data transfer for each processor granted access may be transmitted through the target port and through the multiplexer. Depending on the arbitration method chosen, the arbiter may or may not grant equal access to all requesters, or the arbiter may or may not give equal priority to one or more requestors. By allocating the ports of a multi-port target to service the simultaneous requests of multiple processors at the time of the requests, the utilization of the target ports by the processors may be increased, and the time the requesting processors spend waiting to access the target ports may be reduced, an overall benefit being a greater utilization of access time to highly demanded device resources within the system.

### BACKGROUND OF THE INVENTION

This invention relates in general to the field of processing devices, and in particular to a processor system that allows for simultaneous access by multiple processors to a target memory-mapped peripheral device having multiple ports.

Only recently have advances in materials technology and processor architectures made it possible to realize a multiple-processor system architecture on a single integrated circuit or chip. In modern multiple-processor (“multi-processor”) systems, each processor may also be referred to as a “master” and each processor may share a bus which allows for shared access with the various one or more “target” peripheral devices. This applies to both multiple processors on a single chip and multiple processors distributed across a plurality of chips, with one or more processors per chip.

The term “processor” may generally be understood to refer to a device that has one or more register files, one or more arithmetic logic units and/or non-arithmetic logic units, and an interface to a shared bus, crossbar switch or some other type of interconnection device or data switching fabric. The term “master” may be understood to refer to any type of device, such as a processor or DMA controller, that can initiate a transaction on a bus, a “transaction” being understood to refer to any type of communication of data between devices, such as a read or write of data between a processor and a target memory device. A transaction sequence may typically comprise an initiator device, such as a master, requesting permission from an arbiter to access a target device, eventually being granted access permission, and then accessing the target device through a port to perform the desired communication. A common example may be one of the processors on a multi-processor chip writing data to several memory locations in an SRAM memory after requesting access to a port of the SRAM and being granted access to that port by an arbiter.

Many types of target peripheral devices have a single port, common examples of which are various memory devices such as ROM, SRAM and DRAM. Other types of targets may include without limitation direct memory access (“DMA”) devices, buffers (e.g., FIFO's), various input/output devices, a device with registers, or some other type of functional device. Note that a DMA controller may also be considered to be a processor or master. A “target” may be understood to refer to any device that has at least one address which may be accessible by a master communicating over a bus. A multiple port target may be one that can be accessed simultaneously through the multiple ports on the target by as many initiator devices as the target has ports. A target may not necessarily be a device that is limited to one having a data storage function such as a memory. A target may instead be understood in a broader context to include for example a serial port that may have data transmitting and receiving functionality and no data storage functionality.

In the case of a target with a single port, an arbiter is usually required to resolve contention issues if multiple initiator devices such as processors simultaneously request access to the single port of the target. The “initiator” or “initiator device” typically requests permission via the arbiter to access and communicate with the target port, such as through read or write operations. Thus, a “requester” or “requesting device” may be understood to refer to an initiator or initiator device that is requesting permission to access a target device. Further, an “arbiter” may be understood to refer to a device that grants permission to a requestor to access a target in such a way that no conflicts with other requesters and/or targets result. The arbiter may utilize one or more of many different procedures for arbitrating access to the target ports by the plurality of requestors.

However, a target device with a single port and an associated arbiter in a multiple requester environment limits the rate of accesses by the requesters to one requester at a time. This usually requires some requesters to wait for undesirably long periods of time before they are granted access to the single port on the target device.

Processing systems with a target device having two or more ports may often connect each port to a different bus for access by multiple requesters. Here, each bus may or may not have an arbiter to arbitrate between the multiple requestors. However, a system with a different bus connected to each target port usually means that for multiple requesters on one of the busses the rate of accesses on that bus may be limited to one requestor at a time, even if another one of the target ports connected to another bus is unused during that time.

However, none of these approaches allow for the target ports to be dynamically and simultaneously allocated to the masters at the time of the access requests.

What is needed is a system arrangement of multiple processors, a multiple port peripheral device and an arbiter that allows for simultaneous and arbitrary access by a multiple of the requesting processors to the multiple ports on a single target.

### SUMMARY OF THE INVENTION

A processor system includes a plurality or multiple of processors along with a target device, for example a memory device, having two or more ports to allow access to within the target device, for example by a processor to access a port to read data from one or more memory locations within the target. The target device may allow for simultaneous and arbitrary access by the processors to all or less than all of the target ports, depending on the number of processors requesting access to the target at any one time. The system may also include an arbiter device that may arbitrate the requests for access by the multiple of processors to the multiple ports on the target device and may ultimately grant such access depending on one of many possible arbitration procedures. In one embodiment, a separate arbiter is provided for each port, while in another embodiment a single arbiter is provided for all ports. A multiplexer may be included that facilitates the flow of control and data information over one or more shared busses that may connect the processors, target and arbiter. The shared bus may be a crossbar switch, a data switching fabric or some type of interconnection device that allows multiple simultaneous transactions.

In use, the number of processors requesting access may be greater than the number of ports on the target device. Each processor may be an initiator device that can issue a request for access to communicate with the target through one of its ports at any time by a transaction, such as a read or write of data operation. The arbiter may receive all incoming requests from the processors and may grant access to as many requesters as are issuing requests up to but not exceeding the number of ports on the target device.

Thus, the arbiter dynamically allocates the target ports to the corresponding requesting processors at the time of the request for access. This may occur within each system clock cycle, and each access typically lasts for one clock cycle, although an access can last for more than one clock cycle.

The data transfer for each requestor that is granted access at any time may be transmitted through one of the target ports and through the multiplexer that is dedicated or associated with that port. Depending on the arbitration method chosen, the arbiter may or may not grant equal access to all requesters, or the arbiter may or may not give equal priority to one or more requestors.

The processor system may be utilized as a system with requestors accessing targets with a multiple of ports that are capable of simultaneously handling a corresponding multiple of requests. This includes but is not limited to ASIC, ASSP, structured ASIC, FPGA and system-on-chip devices with multi-layered busses, crossbar switches, or interconnection fabrics.

Multiple processors on a crossbar switch, data switching fabric or other interconnection between devices can simultaneously request access to a single target. The system allows that for as many ports as the target device has, that same number of processors, or a smaller number of processors, may be granted simultaneous access to those target ports. In one embodiment, that access may be arbitrary. The system may for example be a multi-processor system accessing shared dual-port SRAM memory.

By allocating the ports of a multi-port target device to service the requests of multiple initiators or requestors at the time of the simultaneous requests, the utilization of the target ports and thus the target devices themselves by the processors may be increased. As a result, the time that the requesting processors wait for access to the target ports as a result of contention between multiple simultaneous requests may be reduced, an overall benefit being a better utilization of available bandwidth to frequently requested target devices.

These and other objects, features and advantages of the present invention will become more apparent in light of the following detailed description of preferred embodiments thereof, as illustrated in the accompanying drawings.

### BRIEF DESCRIPTION OF THE DRAWINGS

FIG. 1 is a block diagram of an embodiment of a processor system that allows for simultaneous access by a multiple of processors to a target peripheral device having a multiple of ports; and

FIG. 2 is a block diagram and alternative embodiment of the processor system of FIG. 1.

### DETAILED DESCRIPTION OF THE INVENTION

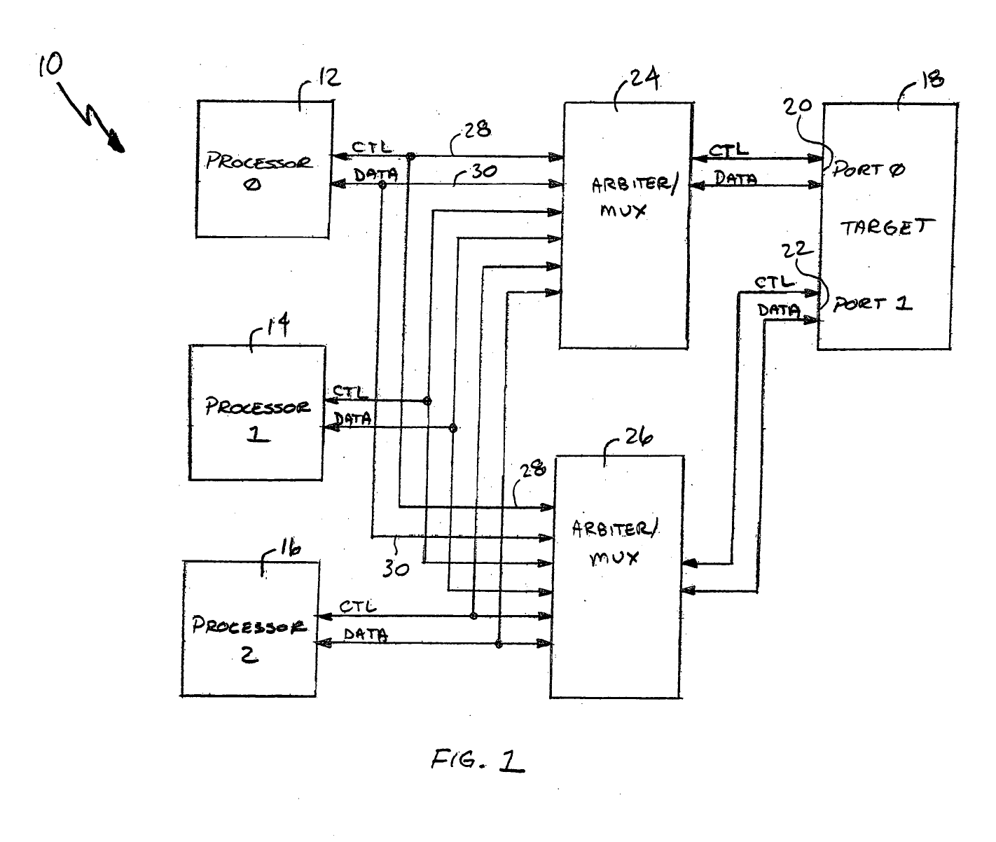

Referring to FIG. 1, an embodiment of a processor system 10 may include three separate processors 12, 14, 16, labeled “PROCESSOR 0”, “PROCESSOR 1”, and “PROCESSOR 2”, respectively. The system may also include a target device 18 having two ports, a first port 20 labeled “PORT 0” and a second port 22 labeled “PORT 1”. The ports 20, 22 may have different addresses such that the ports 20, 22 are separately addressable. The target device 18 may comprise a type of memory, such as a two-port SRAM. As such, the ports 20, 22 may be thought of as separate windows allowing access to the large number of data storage locations within the memory device 18. As described hereinbefore, however, the target device 18 may or may not comprise one with a data storage function. Instead, the target device 18 may comprise without limitation a data transmission or reception device, a data transformation device, or a bridge or controller for an interconnection network.

The system 10 may also include a pair of arbiter and multiplexer circuit arrangements 24, 26 (“arbiter/mux”). Each arbiter/mux circuit 24, 26 may have its own separate address such that the circuits 24, 26 are separately addressable by the processors 12-16. In this embodiment, each arbiter/mux circuit 24, 26 may be dedicated to a port on the target device 18 such that when a processor 12-16 selects a particular arbiter/mux circuit 24, 26 the processor is also selecting a particular port 20, 22 on the target device 18.

A data switching fabric is included in the system 10, such as a bus that connects the various control, address and data signal lines between the processors 12-16, target 18 and arbiter/mux circuits 24, 26.

All of these components may be embodied in a single integrated circuit or chip, or they may be embodied in more than one chip with certain components on one chip and other components on one or more other chips.

In operation, a processor 12-16 may desire to initiate a transaction with the target device 18, such as a data communication in the form of a read data or write data operation. For example, the first processor 12 (PROCESSOR 0) may initiate a transaction by issuing an address word comprising for example thirty-two bits on a control bus 28, the bus 28 having a plurality of control lines interconnecting the processor 12 and the two arbiter/mux circuits 24, 26. The control bus 28 may include one or more additional signal lines that control for example whether the desired transaction is a read data or write data operation. Also, the control bus 28 may contain signal lines that indicate for example whether a request to an arbiter/mux 24, 26 to access the target device 18 had been granted or if instead the processor 12 must waif for access to be granted because the desired port 20, 22 is currently in use. The upper bits of the address word on the control bus 28 may specify the address of the particular arbiter/mux circuit 24, 26 as between the two circuits 24, 26 in FIG. 1. The lower bits of the address word on the control bus 28 may specify the particular data location within the target memory device 18 that is to be accessed for the data read or write operation.

In this example, the first processor 12 may desire to write data to one or more locations within the memory device 18. To do so, the first processor 12 may address the first arbiter/mux circuit 24 to gain access to the first port 20. When the first processor 12 is granted access by the arbiter/mux circuit 24 to the first port 20, the first processor 12 may send the data to be written on a data bus 30 to the arbiter/mux circuit 24 which may pass the data on to the first port 20 for the writing of the data in the target memory device 18 at the desired locations.

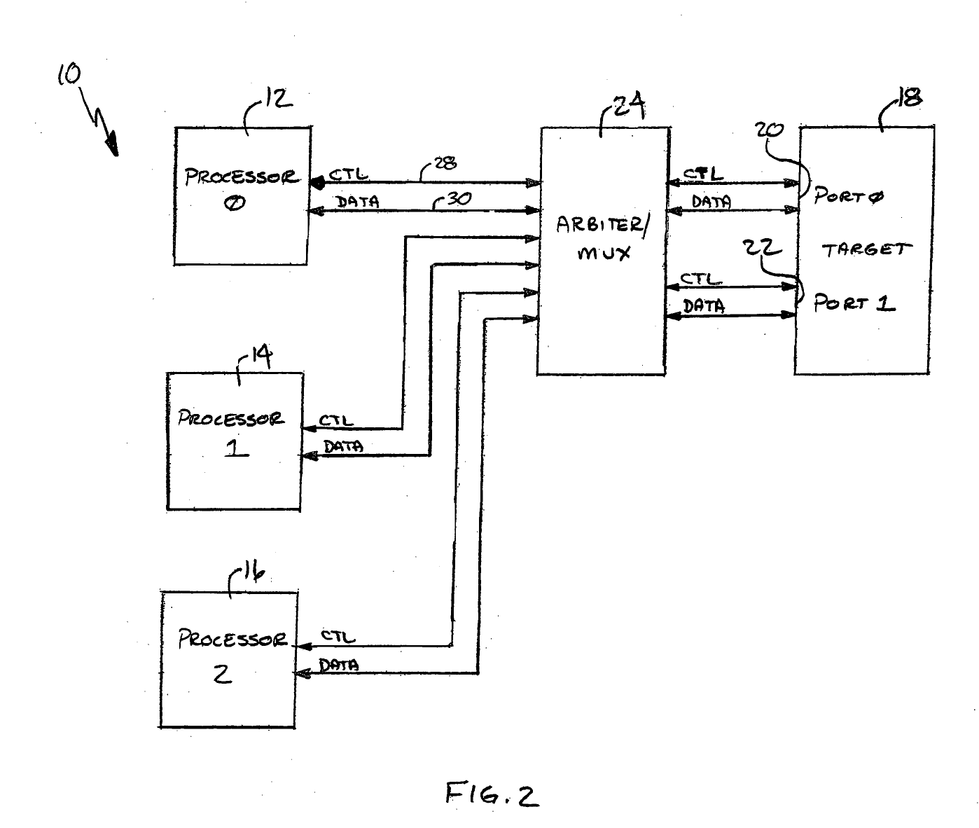

In this same example, at the same time as the first processor 12 is requesting access to the first arbiter/mux circuit 24 and corresponding first port 20 for a transaction, the second and third processors 14, 16 may both desire access to the second arbiter/mux circuit 26 to access the second port 22 of the target memory device 18 for a particular transaction. As such; a contention condition will now exist between the second processor 14 and the third processor 16 for the right to access the second port 22. The second arbiter/mux circuit 26 that corresponds to the second port 22 will arbitrate the contention and select between the second and third processors 14, 16 to allow one of these processors 14, 16 to access the second port 22. In this embodiment, the need to arbitrate between the second and third processors 14, 16 for access to the second port would exist even if the first processor 12 was not requesting access to the first port 20. Thus, in this situation the first port 20 may sit idle and not be accessed while the second port 22 is being accessed by either of the second and third processors 14, 16. However, this is not the case with the second embodiment of the processor system 10 of FIG. 2, as described hereinafter.

Thus, at the same time the first processor 12 is accessing the first port 20 via the first arbiter/mux circuit 24, one of the second and third processors 14, 16 will have simultaneous access to the second port 22 via the second arbiter/mux circuit 26. When one of the second or third processors 14, 16 has completed its access of the second port 22, then the other one of the second and third processors 14, 16 may then be granted access to the second port 22 via the second arbiter/mux circuit 26.

The arbiter/mux circuits 24, 26 may utilize any procedure for arbitrating between at least two of the processors 12-16 to determine which one of the processors 12-16 will be granted access to a port 20, 22. Depending on the arbitration method chosen, the arbiter/mux 24, 26 may or may not grant equal access to all requesters, or the arbiter/mux 24, 26 may or may not give equal priority to one or more requesters. For example, when the number of requesting processors 12-16 exceeds the number of target ports 20, 22, the arbitration method may comprise a round-robin order of granting access, a random order of granting access, a priority order where one or more of the processors/initiators 12-16 may have priority over one or more of the other processors/initiators 12-16, or a combination of the above arbitration methods.

Thus, under a condition where the number of processors/initiators 12-16 requesting access to the target 18 is the same or is fewer than the number of ports 20, 22 on the target 18, each initiator 12-16 requesting access may be granted access to a port 20, 22 by the associated arbiter/mux circuit 24, 26. Also, under a condition where the number of initiators or processors 12-16 requesting access to the ports 20, 22 may be larger than the number of ports on the target 18, one initiator will be granted access for each target port by the associated arbiter/mux 24, 26, but one or more initiators 12-16 may not be granted access simultaneously with those that are granted access. This is because now there exists a condition at a moment in time where there are more processors 12-16 requesting access than there are available ports 20, 22. Thus, some number of initiators 12-16 requesting access in excess of the number of target ports 20, 22 will not be granted access simultaneously, and will have to wait for a period of time for access until the arbiter/mux circuits 24, 26 determine that access may be appropriate. Nevertheless, in this embodiment, each port 20, 22 may be considered to be available to each processor 12-16, albeit in some situations described hereinabove not all processors 12-16 may be able to simultaneously access all of the ports 20, 22.

In the embodiment of FIG. 1, because the arbiter/mux circuits 24, 26, and thus also the ports 20, 22, are separately addressable, the responsibility for having a processor 12-16 select a port 20, 22 resides with the software program executed by one or more of the processors 12-16 within the system 10, and, thus, the responsibility resides with the programmer of the software program. Nevertheless, the system 10 of the embodiment of FIG. 1 may include an arbiter/mux circuit 24, 26 to arbitrate between requests as there may be situations where, without arbitration, a conflict between requesting processors 12-16 may result. Yet, in this embodiment, the chances for conflict may be statistically reduced as compared to the prior art primarily because the processors 12-16 may be considered to be operating independently of each other.

Referring to FIG. 2, an alternative embodiment illustrated there of the processor system 10 of FIG. 1 may be considered to be somewhat similar to the embodiment of FIG. 1. Similar reference numerals in FIG. 2 as in FIG. 1 designate similar components in FIGS. 1 and 2. The primary difference between the systems 10 of FIGS. 1 and 2 is that in FIG. 2 there may be a single arbiter/mux circuit 24 to arbitrate all of the access requests to all of the ports 20, 22 on the target device 18. As such, the feature of the embodiment of the system 10 of FIG. 1 where each arbiter/mux circuit 24, 26 may be separately addressable may no longer exist in the embodiment of FIG. 2.

The system 10 of FIG. 2 has an advantage in that it is no longer necessary to have the software program and programmer responsible for having the processors 12-16 select the ports 20, 22. Instead, the processors/initiators 12-16 may desire access to any of the ports 20, 22 and in response, the arbiter/mux circuit 24 may select or allocate any of the available ports 20, 22 in an arbitrary manner for access thereto by the requesting processors 12-16.

Thus, in the embodiment of the processor system 10 of FIG. 2, the arbiter/mux circuit 24 may be considered to be dynamically and arbitrarily allocating each of the available target ports 20, 22 to requesting processors 12-16 at the time of the request for access. This may occur within each system clock cycle, and each access typically lasts for one clock cycle, although an access can last for more than one clock cycle, depending upon the type of processor operation. If an access by a processor 12-16 to a target port 20, 22 lasts for a single clock cycle, then the arbitration process described hereinabove may occur at the beginning of each and every clock cycle.

As illustrated and described herein, the processor system 10 embodiments of FIGS. 1 and 2 include one more processor 12-16 in number than the number of ports 20, 22 on the target device 18. In particular, the system 10 has three processors 12-16 and two target ports 20, 22. However, the broadest scope contemplates that any number of a plurality of processors and the same number of ports on a target device be utilized. However from a practical perspective, if the same number of processors and ports existed, then it would be a simple matter of dedicating each of the processors to a corresponding one of the ports, and as such an arbiter along with a dynamic allocation procedure would not be needed. In contrast, the processor system 10 described and illustrated herein may be better suited for a situation where there is at least one more processor than the number of ports, and the benefits are multiplied the greater the number of possible requestors than parts of the target.

Although the present invention has been illustrated and described with respect to several preferred embodiments thereof, various changes, omissions and additions to the form and detail thereof, may be made therein, without departing from spirit and scope of the invention.

What is claimed is:

1. A processor system, comprising:
a target device with at least N number of ports;
at least M number of processor devices that can each initiate a request for a transaction with the target device through one of the N number of ports; and
at least N number of arbiter devices, each one of the N number of arbiter devices being dedicated to a corresponding each one of the N number of ports on the target device, each one of the N number of arbiter devices allowing each one of the corresponding N number of ports on the target device to be accessed by each one of the M number of processor devices.

2. The processor system of claim 1, where N equals M.

3. The processor system of claim 1, where N equals 2.

4. The processor system of claim 1, where M equals three.

5. The processor system of claim 1, where M is at least one number larger than N.

6. The processing system of claim 1, where the target device comprises a data storage device.

7. The processing system of claim 1, where the target device comprises a device from the group comprising a data storage device, a data transmission device, a data reception device, a data transformation device, a bridge for an interconnection device, and a controller for an interconnection device.

8. The processing system of claim 1, where N is greater than one, and where the N number of arbiter devices allow each one of the M number of processor devices to simultaneous access each one of N number of ports on the target device.

9. A processor system, comprising:
a target device with at least N number of ports;
at least M number of processor devices that can each initiate a request for a transaction with the target device through one of the N number of ports; and
an arbiter device that allocates one of the N number of ports of the target device to a transaction requested of the target device by one of the M number of processor devices, where the arbiter device simultaneously allocates a number of the at least N number of ports of the target device to the same number of the at least M number of processor devices that initiate a request for a transaction with the target device such that where at most the same number of processors are initiating a request for access as are the number of the ports on the target then all of the processors gain access to the ports regardless of which combination of the processors are initiating a request for access.

10. The processor system of claim 9, where N equals M.

11. The processor system of claim 9, where N equals 2.

12. The processor system of claim 9, where M equals three.

13. The processor system of claim 9, where M is at least one number larger than N.

14. The processing system of claim 9, where the target device includes a data storage function.

15. The processing system of claim 9, where the target device comprises a device from the group comprising a data storage device, a data transmission device, a data reception device, a data transformation device, a bridge for an interconnection device, and a controller for an interconnection device.

16. The system of claim 9, where the arbiter device allocates at least one of the N number of target ports for data transfers requested of the target by at least one of the M number of processor devices using a round-robin order.

17. The system of claim 9, where the arbiter device allocates at least one of the N number of target ports for data transfers requested of the target by at least one of the M number of processor devices using a priority order.

18. A processor system, comprising:
a target device with at least two ports;
at least three processor devices that can each initiate a request for a transaction with the target device through one of the two ports of the target device; and
an arbiter device that allocates one of the two ports of the target device to a transaction requested of the target device by one of the three processor devices, where the arbiter device allocates a number of the at least two ports of the target device to the same number of the at least three processor devices that initiate a request for a transaction with the target device.

19. The processor system of claim 18, where the target device comprises a memory.

20. The processor system of claim 18, where the arbiter device simultaneously allocates a number of the ports of the target device to a corresponding number of the processor devices when at least two transactions are requested of the target device.
